SEQUENCE LISTING (147 sequences)

SEQ ID NO: 1 - DNA, 19 bp, Artificial Sequence
  Synthetic nucleic acid; forward primer to Adenovirus - Type A.
ggcacatgcgagccaaatc

SEQ ID NO: 2 - DNA, 18 bp, Artificial Sequence
  Synthetic nucleic acid; forward primer to Adenovirus - Type B.
gcacctgcgagccaaatc

SEQ ID NO: 3 - DNA, 17 bp, Artificial Sequence
  Synthetic nucleic acid; forward primer to Adenovirus - Type B.
cacctgcgaggccaacc

SEQ ID NO: 4 - DNA, 18 bp, Artificial Sequence
  Synthetic nucleic acid; forward primer to Adenovirus - Type C.
gcacatgcgagcccaacc

SEQ ID NO: 5 - DNA, 17 bp, Artificial Sequence
  Synthetic nucleic acid; forward primer to Adenovirus - Type E.
cacctgcgagcccaacc

SEQ ID NO: 6 - DNA, 28 bp, Artificial Sequence
  Synthetic nucleic acid; forward primer to Coronavirus - Type SARS.
gtaacttatcacaccgtttctacaggtt

SEQ ID NO: 7 - DNA, 23 bp, Artificial Sequence
  Synthetic nucleic acid; forward primer to Coronavirus - Types HKU1 and OC43.
ttgaaggctcaggaaggtctgct

SEQ ID NO: 8 - DNA, 29 bp, Artificial Sequence
  Synthetic nucleic acid; forward primer to Coronavirus - Type NL63.
ggtgttttgcataaggcatatgttgatgt

SEQ ID NO: 9 - DNA, 29 bp, Artificial Sequence
  Synthetic nucleic acid; forward primer to Coronavirus - Type 229E.
ggtgctttacacaaggcatacattgatgt

SEQ ID NO: 10 - DNA, 15 bp, Artificial Sequence
  Synthetic nucleic acid; forward primer to Enterovirus - Types A, B, C, and D.
tggctgcgytggcgg

SEQ ID NO: 11 - DNA, 16 bp, Artificial Sequence
  Synthetic nucleic acid; forward primer to Rhinovirus - Types A and B.
agcctgcgtggckgcc

SEQ ID NO: 12 - DNA, 22 bp, Artificial Sequence
  Synthetic nucleic acid; forward primer to Influenza Virus - Type B.
ggtgttgcaatcaaaggaggtg

SEQ ID NO: 13 - DNA, 22 bp, Artificial Sequence
  Synthetic nucleic acid; forward primer to Influenza Virus - Type B.
ggtgttgcgatcaaaggaggtg

SEQ ID NO: 14 - DNA, 20 bp, Artificial Sequence
  Synthetic nucleic acid; forward primer to Influenza Virus - Type A.
ggcgctgcagtcaaaggart

SEQ ID NO: 15 - DNA, 20 bp, Artificial Sequence
  Synthetic nucleic acid; forward primer to Influenza Virus - Type A.
ggtgctgcagtcaaaggart

SEQ ID NO: 16 - DNA, 26 bp, Artificial Sequence
  Synthetic nucleic acid; forward primer to HMPV.
gccgttagcttcagtcaattcaacag

SEQ ID NO: 17 - DNA, 26 bp, Artificial Sequence
  Synthetic nucleic acid; forward primer to HMPV.
gctgtcagcttcagtcaattcaacag

SEQ ID NO: 18 - DNA, 24 bp, Artificial Sequence
  Synthetic nucleic acid; forward primer to HRSV.
gaatgcctatggtkcagggcaagt

SEQ ID NO: 19 - DNA, 24 bp, Artificial Sequence
  Synthetic nucleic acid; forward primer to HRSV.
gaatgcctatggttcaggacaagt

SEQ ID NO: 20 - DNA, 24 bp, Artificial Sequence
  Synthetic nucleic acid; forward primer to HPIV - Type 1.
acaggaattggctcagatatgyga

SEQ ID NO: 21 - DNA, 29 bp, Artificial Sequence
  Synthetic nucleic acid; forward primer to HPIV - Type 3.
acagatgtatatcaactgtgttcractcc

SEQ ID NO: 22 - DNA, 23 bp, Artificial Sequence
  Synthetic nucleic acid; forward primer to HPIV - Type 4.
gctytagctgcattttctggtga

SEQ ID NO: 23 - DNA, 22 bp, Artificial Sequence
  Synthetic nucleic acid; forward primer to HPIV - Type 2.
taacaaaccctgcgcctgacac

SEQ ID NO: 24 - DNA, 23 bp, Artificial Sequence
  Synthetic nucleic acid; forward primer to Armored RNA.
cactcccctgtgaggaactactg

SEQ ID NO: 25 - DNA, 24 bp, Artificial Sequence
  Synthetic nucleic acid; reverse primer to SEQ ID No. 1.
ctcttccaaggacacaatcccagg

SEQ ID NO: 26 - DNA, 29 bp, Artificial Sequence
  Synthetic nucleic acid; reverse primer to SEQ ID Nos. 2 and 3.
ggaacctcttccaaggaagctatatcagg

SEQ ID NO: 27 - DNA, 21 bp, Artificial Sequence
  Synthetic nucleic acid; reverse primer to SEQ ID No. 4.
gtygagcgaggcgatatcagg

SEQ ID NO: 28 - DNA, 24 bp, Artificial Sequence
  Synthetic nucleic acid; reverse primer to SEQ ID No. 5.
ctcttccaaggaggcgatatcagg

SEQ ID NO: 29 - DNA, 29 bp, Artificial Sequence
  Synthetic nucleic acid; reverse primer to SEQ ID No. 6.
actattagcataagcagttgtagcatcac

SEQ ID NO: 30 - DNA, 25 bp, Artificial Sequence
  Synthetic nucleic acid; reverse primer to SEQ ID No. 7.
tgcttagtkacttgctgaggtttag

SEQ ID NO: 31 - DNA, 22 bp, Artificial Sequence
  Synthetic nucleic acid; reverse primer to SEQ ID No. 8.
accttagaaccggcacgcatac

SEQ ID NO: 32 - DNA, 22 bp, Artificial Sequence
  Synthetic nucleic acid; reverse primer to SEQ ID No. 9.
accttagcacctgcacgcatac

SEQ ID NO: 33 - DNA, 23 bp, Artificial Sequence
  Synthetic nucleic acid; reverse primer to SEQ ID Nos. 10 and 11.
gaaacacggacacccaaagtagt

SEQ ID NO: 34 - DNA, 27 bp, Artificial Sequence
  Synthetic nucleic acid; reverse primer to SEQ ID Nos. 12-13.
tggrttyctacttccgatcacttgatc

SEQ ID NO: 35 - DNA, 22 bp, Artificial Sequence
  Synthetic nucleic acid; reverse primer to SEQ ID Nos. 14-15.
cccgrctytctctcacttgatc

SEQ ID NO: 36 - DNA, 19 bp, Artificial Sequence
  Synthetic nucleic acid; reverse primer to SEQ ID No. 16.
cctgcagatgtyggcatgt

SEQ ID NO: 37 - DNA, 20 bp, Artificial Sequence
  Synthetic nucleic acid; reverse primer to SEQ ID No. 17.
ycctgcagatgttggcatgt

SEQ ID NO: 38 - DNA, 23 bp, Artificial Sequence
  Synthetic nucleic acid; reverse primer to SEQ ID Nos. 18 and 19.
ccattatgcctagacctgctgca

SEQ ID NO: 39 - DNA, 26 bp, Artificial Sequence
  Synthetic nucleic acid; reverse primer to SEQ ID Nos. 18 and 19.
ccagcagcattgcctaatactacact

SEQ ID NO: 40 - DNA, 26 bp, Artificial Sequence
  Synthetic nucleic acid; reverse primer to SEQ ID Nos. 18 and 19.
gcagcattgcctaatactacactgga

SEQ ID NO: 41 - DNA, 30 bp, Artificial Sequence
  Synthetic nucleic acid; reverse primer to SEQ ID No. 20.
gacttccctatatctgcacatccttgagtg

SEQ ID NO: 42 - DNA, 26 bp, Artificial Sequence
  Synthetic nucleic acid; reverse primer to SEQ ID No. 21.
ttggatgttcaagacctccatayccg

SEQ ID NO: 43 - DNA, 24 bp, Artificial Sequence
  Synthetic nucleic acid; reverse primer to SEQ ID No. 22.
aactgttccctggtgcttcattgc

SEQ ID NO: 44 - DNA, 24 bp, Artificial Sequence
  Synthetic nucleic acid; reverse primer to SEQ ID No. 22.
aactgttccttgatgtttcattgc

SEQ ID NO: 45 - DNA, 22 bp, Artificial Sequence
  Synthetic nucleic acid; reverse primer to SEQ ID No. 23.
caattaccttcgcaccgggttg

SEQ ID NO: 46 - DNA, 24 bp, Artificial Sequence
  Synthetic nucleic acid; reverse primer to SEQ ID No. 24.
aggctgcacgacactcatactaac

SEQ ID NO: 47 - DNA, 26 bp, Artificial Sequence
  Synthetic nucleic acid; primer to PIV - Type 1 - for primer extension.
ttctggagatgtcccgtaggagagcc

SEQ ID NO: 48 - DNA, 23 bp, Artificial Sequence
  Synthetic nucleic acid; primer to Adenovirus - Type A for primer extension.
cagcccttaaagcaagaagctca

SEQ ID NO: 49 - DNA, 21 bp, Artificial Sequence
  Synthetic nucleic acid; primer to Adenovirus - Type B for primer extension.
ggtcccagattgagtagggca

SEQ ID NO: 50 - DNA, 21 bp, Artificial Sequence
  Synthetic nucleic acid; primer to Adenovirus - Type B for primer extension.
ggacccaagttgagmagggca

SEQ ID NO: 51 - DNA, 18 bp, Artificial Sequence
  Synthetic nucleic acid; primer to Adenovirus - Type C for primer extension.
cgcaaggccagctgcttg

SEQ ID NO: 52 - DNA, 20 bp, Artificial Sequence
  Synthetic nucleic acid; primer to Adenovirus - Type E for primer extension.
ggcccaggttgaaaagggag

SEQ ID NO: 53 - DNA, 20 bp, Artificial Sequence
  Synthetic nucleic acid; primer to Adenovirus - Type E for primer extension.
ggcccaggtcgaaaagggcg

SEQ ID NO: 54 - DNA, 27 bp, Artificial Sequence
  Synthetic nucleic acid; primer to Coronavirus - Type OC43 - for primer extension.
ctcctaattccagatctacttcgcgca

SEQ ID NO: 55 - DNA, 28 bp, Artificial Sequence
  Synthetic nucleic acid; primer to Coronavirus - Type HKU1 - for primer extension.
gcttctaatagtcgaccaggttcacgtt

SEQ ID NO: 56 - DNA, 27 bp, Artificial Sequence
  Synthetic nucleic acid; primer to Coronavirus - Type 229E - for primer extension.
atgctaatatgtctttagccgagtgca

SEQ ID NO: 57 - DNA, 26 bp, Artificial Sequence
  Synthetic nucleic acid; primer to Coronavirus - Type NL63 - for primer extension.
ctgctaacatgtccatggctgaatgt

SEQ ID NO: 58 - DNA, 22 bp, Artificial Sequence
  Synthetic nucleic acid; primer to Coronavirus - Type SARS - for primer extension.
gctaacgagtgtgcgcaagtat

SEQ ID NO: 59 - DNA, 18 bp, Artificial Sequence
  Synthetic nucleic acid; primer to Rhinovirus and Enterovirus for primer extension.
cattcaggggccggagga

SEQ ID NO: 60 - DNA, 18 bp, Artificial Sequence
  Synthetic nucleic acid; primer to Enterovirus - Type A - for primer extension.
aggggccggaggactact

SEQ ID NO: 61 - DNA, 18 bp, Artificial Sequence
  Synthetic nucleic acid; primer to Enterovirus - Type B - for primer extension.
aggggccggaggattacc

SEQ ID NO: 62 - DNA, 18 bp, Artificial Sequence
  Synthetic nucleic acid; primer to Enterovirus - Type C - for primer extension.
aggggccggaggactctt

SEQ ID NO: 63 - DNA, 18 bp, Artificial Sequence
  Synthetic nucleic acid; primer to Enterovirus - Type D - for primer extension.
aggggccggaggactctc

SEQ ID NO: 64 - DNA, 24 bp, Artificial Sequence
  Synthetic nucleic acid; primer to Rhinovirus - Type A - for primer extension.
gaatgyggctaaccttaamcctgc

SEQ ID NO: 65 - DNA, 24 bp, Artificial Sequence
  Synthetic nucleic acid; primer to Rhinovirus - Type A - for primer extension.
gaatgtggctaatcctaaccctgc

SEQ ID NO: 66 - DNA, 24 bp, Artificial Sequence
  Synthetic nucleic acid; primer to Rhinovirus - Type B - for primer extension.
gaatgcggctaaccttaaccctag

SEQ ID NO: 67 - DNA, 27 bp, Artificial Sequence
  Synthetic nucleic acid; primer to Influenza - Type A - for primer extension.
gatggarctgatcagaatgrtcaaacg

SEQ ID NO: 68 - DNA, 27 bp, Artificial Sequence
  Synthetic nucleic acid; primer to Influenza - Type A - for primer extension.
gatggagttgatmaggatgatcaaacg

SEQ ID NO: 69 - DNA, 27 bp, Artificial Sequence
  Synthetic nucleic acid; primer to Influenza - Type A - for primer extension.
tggagttaatyaggatgatcaaacgtg

SEQ ID NO: 70 - DNA, 27 bp, Artificial Sequence
  Synthetic nucleic acid; primer to Influenza - Type B - for primer extension.
tggctgaagccattcgatttataggaa

SEQ ID NO: 71 - DNA, 28 bp, Artificial Sequence
  Synthetic nucleic acid; primer to HMPV - Type A - for primer extension.
ggaataacaccagcaatatctttggact

SEQ ID NO: 72 - DNA, 31 bp, Artificial Sequence
  Synthetic nucleic acid; primer to HMPV - Type A - for primer extension.
gctggaataacaccagcaatatctttagact

SEQ ID NO: 73 - DNA, 28 bp, Artificial Sequence
  Synthetic nucleic acid; primer to HMPV - Type B - for primer extension.
gggataacaccagcaatatcattggacc

SEQ ID NO: 74 - DNA, 24 bp, Artificial Sequence
  Synthetic nucleic acid; primer to HRSV - Type A - for primer extension.
cctgcttctccacccaatttctga

SEQ ID NO: 75 - DNA, 24 bp, Artificial Sequence
  Synthetic nucleic acid; primer to HRSV - Type A - for primer extension.
cctgcttctccacccaatttctgg

SEQ ID NO: 76 - DNA, 24 bp, Artificial Sequence
  Synthetic nucleic acid; primer to HRSV - Type A - for primer extension.
cctgcttctccacccaatttttgg

SEQ ID NO: 77 - DNA, 24 bp, Artificial Sequence
  Synthetic nucleic acid; primer to HRSV - Type B - for primer extension.
ccagcttctcctcccaacttctgt

SEQ ID NO: 78 - DNA, 26 bp, Artificial Sequence
  Synthetic nucleic acid; primer to PIV - Type 1 - for primer extension.
ttctggagatgtcccgtaggagaacc

SEQ ID NO: 79 - DNA, 20 bp, Artificial Sequence
  Synthetic nucleic acid; primer to PIV - Type 2 - for primer extension.
cctcctcggtagcaccttgc

SEQ ID NO: 80 - DNA, 25 bp, Artificial Sequence
  Synthetic nucleic acid; primer to PIV - Type 3 - for primer extension.
gtatatccctggtccaacagatggg

SEQ ID NO: 81 - DNA, 27 bp, Artificial Sequence
  Synthetic nucleic acid; primer to PIV - Type 4 - for primer extension.
ggtgacagatcaagatayttggctctc

SEQ ID NO: 82 - DNA, 23 bp, Artificial Sequence
  Synthetic nucleic acid; extension primer to Armored RNA internal control.
gtcttcacgcagaaagcgtctag

SEQ ID NO: 83 - DNA, 23 bp, Artificial Sequence
  Synthetic nucleic acid; PCR primer to PIV - Type 1
acaggaattggctcagatatgyg

SEQ ID NO: 84 - DNA, 30 bp, Artificial Sequence; identical to SEQ ID NO: 41
  Synthetic nucleic acid; PCR primer to PIV - Type 1

SEQ ID NO: 85 - DNA, 23 bp, Artificial Sequence
  Synthetic nucleic acid; PCR primer to PIV - Type 2.
gctcttgcagcattttctgggga

SEQ ID NO: 86 - DNA, 20 bp, Artificial Sequence
  Synthetic nucleic acid; PCR primer to PIV - Type 2
gctccctgctgtttccttgc

SEQ ID NO: 87 - DNA, 29 bp, Artificial Sequence
  Synthetic nucleic acid; PCR primer to PIV - Type 3.
acagatgtatatcaactgtgttcractcc

SEQ ID NO: 88 - DNA, 26 bp, Artificial Sequence
  Synthetic nucleic acid; PCR primer to PIV - Type 3.
ttggatgttcaagacctccatayccg

SEQ ID NO: 89 - DNA, 23 bp, Artificial Sequence
  Synthetic nucleic acid; PCR primer to PIV - Type 4A.
gctytagctgcattttctggtga

SEQ ID NO: 90 - DNA, 24 bp, Artificial Sequence
  Synthetic nucleic acid; PCR primer to PIV - Type 4B.
aactgttccctggtgcttcattgc

SEQ ID NO: 91 - DNA, 24 bp, Artificial Sequence
  Synthetic nucleic acid; PCR primer to PIV - Type 4B.
aactgttccttgatgtttcattgc

SEQ ID NO: 92 - DNA, 23 bp, Artificial Sequence
  Synthetic nucleic acid; PCR primer to HRSV - Type A.
ccattatgcctagacctgctgca

SEQ ID NO: 93 - DNA, 26 bp, Artificial Sequence
  Synthetic nucleic acid; PCR primer to HRSV - Type B.
ccagcagcattgcctaatactacact

SEQ ID NO: 94 - DNA, 26 bp, Artificial Sequence
  Synthetic nucleic acid; PCR primer to HRSV - Type B.
gcagcattgcctaatactacactgga

SEQ ID NO: 95 - DNA, 24 bp, Artificial Sequence
  Synthetic nucleic acid; PCR primer to HRSV - Type B.
gaatgcctatggtkcagggcaagt

SEQ ID NO: 96 - DNA, 22 bp, Artificial Sequence
  Synthetic nucleic acid; PCR primer to HMPV - Type A.
ggctccatgcaaatatgaagtg

SEQ ID NO: 97 - DNA, 27 bp, Artificial Sequence
  Synthetic nucleic acid; PCR primer to HMPV - Type A.
catcagctctatcagtgttccttaaaa

SEQ ID NO: 98 - DNA, 22 bp, Artificial Sequence
  Synthetic nucleic acid; PCR primer to HMPV - Type B.
ggctccatgcaaatatgaagtg

SEQ ID NO: 99 - DNA, 27 bp, Artificial Sequence
  Synthetic nucleic acid; PCR primer to HMPV - Type B.
catcagccttatcwgtgtttcttaaaa

SEQ ID NO: 100 - DNA, 20 bp, Artificial Sequence
  Synthetic nucleic acid; PCR primer to Influenza - Type A.
ggcgctgcagtcaaaggart

SEQ ID NO: 101 - DNA, 20 bp, Artificial Sequence
  Synthetic nucleic acid; PCR primer to Influenza - Type A.
ggtgctgcagtcaaaggart

SEQ ID NO: 102 - DNA, 22 bp, Artificial Sequence
  Synthetic nucleic acid; PCR primer to Influenza - Type A.
cccgrctytctctcacttgatc

SEQ ID NO: 103 - DNA, 22 bp, Artificial Sequence
  Synthetic nucleic acid; PCR primer to Influenza - Type B.
ggtgttgcaatcaaaggaggtg

SEQ ID NO: 104 - DNA, 22 bp, Artificial Sequence
  Synthetic nucleic acid; PCR primer to Influenza - Type B.
ggtgttgcgatcaaaggaggtg

SEQ ID NO: 105 - DNA, 27 bp, Artificial Sequence
  Synthetic nucleic acid; PCR primer to Influenza - Type B.
tggrttyctacttccgatcacttgatc

SEQ ID NO: 106 - DNA, 16 bp, Artificial Sequence
  Synthetic nucleic acid; PCR primer to Enterovirus - Types A, B, C, and D.
agcctgcgtggckgcc

SEQ ID NO: 107 - DNA, 23 bp, Artificial Sequence
  Synthetic nucleic acid; PCR primer to Rhinovirus - Types A and B.
gaaacacggacacccaaagtagt

SEQ ID NO: 108 - DNA, 15 bp, Artificial Sequence
  Synthetic nucleic acid; PCR primer to Rhinovirus - Types A and B.
tggctgcgytggcgg

SEQ ID NO: 109 - DNA, 28 bp, Artificial Sequence
  Synthetic nucleic acid; PCR primer to Coronavirus - Type SARS.
gtaacttatcacaccgtttctacaggtt

SEQ ID NO: 110 - DNA, 29 bp, Artificial Sequence
  Synthetic nucleic acid; PCR primer to Coronavirus - Type SARS.
actattagcataagcagttgtagcatcac

SEQ ID NO: 111 - DNA, 23 bp, Artificial Sequence
  Synthetic nucleic acid; PCR primer to Coronavirus - Type HKU1.
ttgaaggctcaggaaggtctgct

SEQ ID NO: 112 - DNA, 25 bp, Artificial Sequence
  Synthetic nucleic acid; PCR primer to Coronavirus - Type OC43.
tgcttagtkacttgctgaggtttag

SEQ ID NO: 113 - DNA, 28 bp, Artificial Sequence
  Synthetic nucleic acid; PCR primer to Coronavirus - Type 229E.
tagtcttayacacaatggtargccagtg

SEQ ID NO: 114 - DNA, 22 bp, Artificial Sequence
  Synthetic nucleic acid; PCR primer to Coronavirus - Type NL63.
tggctcttccattgttggckcg

SEQ ID NO: 115 - DNA, 23 bp, Artificial Sequence
  Synthetic nucleic acid; PCR primer to Adenovirus - Type A.
ccctcacadatttgcatttccca

SEQ ID NO: 116 - DNA, 24 bp, Artificial Sequence
  Synthetic nucleic acid; PCR primer to Adenovirus - Type B.
ggtaatttatggacccactggctg

SEQ ID NO: 117 - DNA, 20 bp, Artificial Sequence
  Synthetic nucleic acid; PCR primer to Adenovirus - Type C.
atttatggccccaccggatg

SEQ ID NO: 118 - DNA, 20 bp, Artificial Sequence
  Synthetic nucleic acid; PCR primer to Adenovirus - Type C.
atttacggtcccacygggtg

SEQ ID NO: 119 - DNA, 18 bp, Artificial Sequence
  Synthetic nucleic acid; PCR primer to Adenovirus - Type C.
atttacgggcccaccggc

SEQ ID NO: 120 - DNA, 18 bp, Artificial Sequence
  Synthetic nucleic acid; PCR primer to Adenovirus - Type D.
aggatgcatgcgrgggga

SEQ ID NO: 121 - DNA, 21 bp, Artificial Sequence
  Synthetic nucleic acid; PCR primer to Adenovirus - Type E.
gcmttcccttccaagttgcat

SEQ ID NO: 122 - DNA, 23 bp, Artificial Sequence
  Synthetic nucleic acid; PCR primer to Armored RNA.
cactcccctgtgaggaactactg

SEQ ID NO: 123 - DNA, 24 bp, Artificial Sequence
  Synthetic nucleic acid; PCR primer to Armored RNA.
aggctgcacgacactcatactaac

SEQ ID NO: 124 - DNA, 14 bp, Artificial Sequence
  Synthetic nucleic acid; TaqMan sequence to PIV - Type 1.
accatgcagacggc

SEQ ID NO: 125 - DNA, 19 bp, Artificial Sequence
  Synthetic nucleic acid; TaqMan sequence to PIV - Type 2.
ccagaaattaaaagctctc

SEQ ID NO: 126 - DNA, 20 bp, Artificial Sequence
  Synthetic nucleic acid; TaqMan sequence to PIV - Type 3.
tgatgaaagatcagattatg

SEQ ID NO: 127 - DNA, 26 bp, Artificial Sequence
  Synthetic nucleic acid; TaqMan sequence to PIV - Type 4A.
ctgaaatctcttatgtcactatacag

SEQ ID NO: 128 - DNA, 26 bp, Artificial Sequence
  Synthetic nucleic acid; TaqMan sequence to PIV - Type 4B.
ctgaagtcttttatgtcattatacag

SEQ ID NO: 129 - DNA, 16 bp, Artificial Sequence
  Synthetic nucleic acid; TaqMan sequence to HRSV - Type A.
tgcttctccacccaat

SEQ ID NO: 130 - DNA, 17 bp, Artificial Sequence
  Synthetic nucleic acid; TaqMan sequence to HRSV - Type B.
agcttctcctcccaact

SEQ ID NO: 131 - DNA, 18 bp, Artificial Sequence
  Synthetic nucleic acid; TaqMan sequence to HMPV - Type A.
ctaacgagtgtgcgcaag

SEQ ID NO: 132 - DNA, 18 bp, Artificial Sequence
  Synthetic nucleic acid; TaqMan sequence to HMPV - Type B.
ctaacgagtgtgcgcaag

SEQ ID NO: 133 - DNA, 17 bp, Artificial Sequence
  Synthetic nucleic acid; TaqMan sequence to Influenza virus - Type A.
cagaatgatcaaacggg

SEQ ID NO: 134 - DNA, 17 bp, Artificial Sequence
  Synthetic nucleic acid; TaqMan sequence to Influenza virus - Type A.
cagaatggtcaaacggg

SEQ ID NO: 135 - DNA, 17 bp, Artificial Sequence
  Synthetic nucleic acid; TaqMan sequence to Influenza virus - Type A.
aggatgatcaaacgtgg

SEQ ID NO: 136 - DNA, 21 bp, Artificial Sequence
  Synthetic nucleic acid; TaqMan sequence to Influenza virus - Type B.
ccattcgatttataggaagag

SEQ ID NO: 137 - DNA, 16 bp, Artificial Sequence
  Synthetic nucleic acid; TaqMan sequence to Enterovirus - Types A, B, C, and D.
attagccgcattcagg

SEQ ID NO: 138 - DNA, 16 bp, Artificial Sequence
  Synthetic nucleic acid; TaqMan sequence to Rhinovirus - Types A and B.
gttagccrcattcagg

SEQ ID NO: 139 - DNA, 18 bp, Artificial Sequence
  Synthetic nucleic acid; TaqMan sequence to Rhinovirus - Type SARS.
ctaacgagtgtgcgcaag

SEQ ID NO: 140 - DNA, 21 bp, Artificial Sequence
  Synthetic nucleic acid; TaqMan sequence to Rhinovirus - Type HKU1.
taaaacaagattagcgatctc

SEQ ID NO: 141 - DNA, 19 bp, Artificial Sequence
  Synthetic nucleic acid; TaqMan sequence to Rhinovirus - Type OC43.
cagaacaagactagcaatt

SEQ ID NO: 142 - DNA, 22 bp, Artificial Sequence
  Synthetic nucleic acid; TaqMan sequence to Rhinovirus - Type 229E.
aatgcgatctttgattactcca

SEQ ID NO: 143 - DNA, 22 bp, Artificial Sequence
  Synthetic nucleic acid; TaqMan sequence to Rhinovirus - Type NL63.
tatgcgatctttaagtactcca

SEQ ID NO: 144 - DNA, 18 bp, Artificial Sequence
  Synthetic nucleic acid; TaqMan sequence to Adenovirus - Types A, B, and C.
cagatgggggratcatgt

SEQ ID NO: 145 - DNA, 17 bp, Artificial Sequence
  Synthetic nucleic acid; TaqMan sequence to Adenovirus - Types A, B, and C.
cgagggtggaatcatgt

SEQ ID NO: 146 - DNA, 17 bp, Artificial Sequence
  Synthetic nucleic acid; TaqMan sequence to Adenovirus - Types D, E, and F.
aarttccccaagtgcac

SEQ ID NO: 147 - DNA, 14 bp, Artificial Sequence
  Synthetic nucleic acid; TaqMan sequence to Armored RNA.
ttcacgcagaaagc

(19) United States
(12) Patent Application Publication
(10) Pub. No.: US 2011/0046001 A1
(43) Pub. Date: Feb. 24, 2011

(54) Multiplex Assay for Respiratory Viruses

(75) Inventors: Jacques Corbeil, St-Augustin de Desmaures (CA); Fredric Raymond, Quebec (CA); Guy Boivin, Quebec (CA)

Correspondence Address: FISH & ASSOCIATES, PC;ROBERT D. FISH, 2603 Main Street, Suite 1000, Irvine, CA, 92614-6232, US

(73) Assignee: AUTOGENOMICS, INC., Carlsbad, CA (US)

(21) Appl. No.: 12/743,714

(22) PCT Filed: Nov. 20, 2008
(86) PCT No.: PCT/US08/84244

§ 371 Date: Oct. 27, 2010

Related U.S. Application Data
(60) Provisional application No. 60/989,394, filed on Nov. 20, 2007.

(51) Int. Cl. C40B 30/04; C40B 40/06

(52) U.S. Cl. 506/9; 506/16

(57) ABSTRACT

A method of detecting the presence of a plurality of respiratory viruses using a multiplexed diagnostic assay is disclosed. The method provides a plurality of oligonucleotides that each is specific for a specific respiratory virus. A multiplex PCR is run using the oligonucleotides, which produces double-stranded products. The method also provides a plurality of extension oligonucleotides that each is specific for a specific double-stranded product. Each extension oligonucleotide also has a distinct second portion having a unique sequence. A primer extension reaction is run using the extension oligonucleotides, which produces single-stranded products. The single-stranded products are hybridized to a solid carrier.

This application claims priority to our copending U.S. provisional application with the Ser. No. 60/989,394, which was filed Nov. 20, 2007, which is incorporated by reference herein.

### FIELD OF THE INVENTION

The field of the invention is clinical diagnosis, and especially kits and methods in which a multiplexed diagnostic assay is used to detect one or more respiratory virus genotypes.

### BACKGROUND OF THE INVENTION

From the avian flu to severe acute respiratory syndrome (SARS), respiratory viruses are currently the cause of great concern worldwide. Approximately 500 million non-influenza related viral respiratory tract infections (VRTI) episodes occur per year in the United States. These episodes alone had an estimated cost of $39.5 billion for the year 2000, which included $17 billion of direct costs and $22.5 billion of indirect costs. Some respiratory virus illnesses cause a heavy burden in terms of morbidity and mortality, primarily among infants and the elderly. Moreover, it is often difficult to distinguish between the different possible causes of respiratory infections. Many viruses have similar symptoms and their precise diagnosis often requires microbiological laboratory testing. Because of cost and technical limitations, such testing is sporadically performed and only for a limited number of viruses.

For example, traditional detection of respiratory viruses involves observing virus growth on a cell culture with or without direct immunoassays. Though very specific, this method has many disadvantages, as it often lacks sensitivity, is burdensome, requires skilled personnel, and takes between five and ten days before obtaining results. To more efficiently detect a respiratory virus, immunoassays have been developed that measure the concentration of a virus using the reaction of an antibody to its antigen (e.g., various immunoassays are commercially available for influenza A detection). While often relatively inexpensive and rapid, immunoassays are typically limited to the detection of a single virus species, and have reduced sensitivity and specificity. In addition, the development of such tests is impractical for some viruses having many subtypes including for example, enteroviruses.

In response to these deficiencies, certain tests have been developed that use multiplex polymerase chain reaction (PCR) to detect many viruses in one assay. Examples for such PCR-based tests are described in U.S. Pat. No. 6,015,664 to Henrickson et al., and U.S. Pat. No. 6,881,835 to Bai et al. Both Henrickson and Bai utilize primers in a PCR process to amplify viral sequences if present in the sample. The amplified sequences are then hybridized to a solid support. One problem with these methods is the many required washing steps that can result in loss of signal and/or additional noise in the results, as well as increased time and cost for handling and detection. Furthermore, at least some of the detection methods can be cumbersome and have a relatively low sensitivity.

Consequently, although many kits and methods for respiratory virus detection are known in the art, all or almost all of them suffer from one or more disadvantages. Thus, there is still a need to provide kits and methods for genotyping a plurality of respiratory viruses using a multiplex assay.

### SUMMARY OF THE INVENTION

The present invention is directed to a method of facilitating the detection of a plurality of respiratory viruses using a rapid, single-tube multiplexed diagnostic assay with multiplex primer extension. Most preferably, a plurality of oligonucleotides is provided, with each oligonucleotide specific for a respiratory virus or genotype. It should be noted that different respiratory viruses can include different types of a single respiratory virus, as well as different viruses, or any combination thereof By providing oligonucleotides with unique hybridization sequences and different target specificities, multiple viruses can be tested in a single process.

In a particularly preferred embodiment, the oligonucleotides are each selected from the group consisting of SEQ ID Nos. 1-23. This is advantageous as each sequence is complementary to a different respiratory virus, while allowing multiplex PCR at a common temperature profile. At least two reverse oligonucleotides can also be provided, and are preferably selected from the group consisting of SEQ ID Nos. 25-45. While specific sequences have been provided, it is also contemplated to use any equivalent sequence having one or more substitutions, deletions, or additions for one or more of the nucleotides of any of SEQ ID Nos. 1-23 and 25-45, provided that the oligonucleotides retain approximately the same annealing temperatures and the same specificity (infra). Unless a contrary intent is apparent from the context, all ranges recited herein are inclusive of their endpoints, and open-ended ranges should be interpreted to include only commercially practical values.

In further contemplated aspects, instructions can be provided to run a multiplex PCR using the provided oligonucleotides, such that each oligonucleotide produces at least one double-stranded product. Advantageously, a labeled deoxynucleotide triphosphate (dNTP) can be used in the multiplex PCR to allow the double-stranded products to be easily detected and differentiated. The labeled dNTP can comprise any suitable label, and preferably comprises a fluorophor.

It is further preferred that a Shrimp Alkaline Phosphatase/Exonuclease I (SAP/EXO) mixture can be added to the PCR product mixture. Instructions to run a cleanup cycle using the SAP/EXO mixture can also be provided.

In another aspect of the inventive subject matter, a plurality of extension oligonucleotides can be provided with each oligonucleotide having a first portion specific for a double-stranded product of the PCR process. Each oligonucleotide can also have a distinct second portion comprising a unique sequence. This is beneficial as it allows quicker separation and identification of resulting extension products. A spacer coupling the first and second portions can optionally be provided and can be any suitable linker (e.g., internal three carbon spacer, a photo-cleavable spacer, a six carbon glycol spacer, a triethylene glycol spacer, an 18-atom hexaethylene glycol spacer, a 1′,2′-dideoxyribose, etc.).

In a preferred embodiment, the extension oligonucleotides are each selected from the group consisting of SEQ ID Nos. 47-81. This is advantageous as each sequence is complementary to a different PCR product, and allows primer extension at a common temperature profile. While specific sequences have been provided, it is also contemplated to use any equivalent sequence having one or more substitutions, deletions, or additions for one or more of the nucleotides of any of SEQ ID Nos. 47-81, provided that the oligonucleotides retain approximately the same annealing temperatures and the same specificity. In a further contemplated aspect, instructions can be provided to run a primer extension reaction using the extension oligonucleotides, such that each produces at least one single-stranded product. Advantageously, the single-stranded products can be labeled to allow the single-stranded products to be easily detected and differentiated.

Instructions can also be provided to hybridize the single-stranded products to a solid carrier. Any suitable device that facilitates the separation of the double-stranded products can be used as the solid carrier. Preferably, the solid carrier comprises a chip which immobilizes the single-stranded products in a predetermined pattern for later observation. In an alternate embodiment, the solid carrier can comprise a plurality of color-coded beads, with each color of bead having the same nucleotide sequences of immobilized single-stranded products. The solid carrier can also comprise a microarray.

In a further contemplated aspect, instructions can be provided to run a complementary deoxyribonucleic acid (cDNA) synthesis on a sample of ribonucleic acid (RNA) using reverse transcription. This is advantageous as most of the respiratory viruses are RNA viruses.

A particularly contemplated embodiment is a kit for genotyping at least one respiratory virus. The kit can include at least two oligonucleotides. Preferably, the oligonucleotides are selected from the group consisting of SEQ ID Nos. 1-23. The kit can also include at least two extension oligonucleotides preferably selected from the group consisting of SEQ ID Nos. 47-81. The kit can further include at least two reverse oligonucleotides preferably selected from the group consisting of SEQ ID Nos. 25-45. As discussed above, it is contemplated that the oligonucleotides can have one or more substitutions, deletions, or additions for one or more nucleotides without departing from the scope of the present invention. It is also contemplated that the kit can include a SAP/EXO mixture to be used to destroy excess oligonucleotides and dNTPs.

Advantageously, the kit can also include a solid carrier to separate the products and efficiently determine which viruses are present for which nucleic acid. The solid carrier can be any suitable device that facilitates separation and classification of the single-stranded products including for example, a plurality of single-stranded nucleic acids in respective predetermined positions, a plurality of color-coded beads, and a microarray, as discussed above.

Various objects, features, aspects and advantages of the present invention will become more apparent from the following detailed description of preferred embodiments of the invention.

### BRIEF DESCRIPTION OF THE DRAWING

FIG. 1 is a flowchart of a method of facilitating detection of a plurality of respiratory viruses.

FIG. 2 is a diagram of a kit for genotyping a respiratory virus.

### DETAILED DESCRIPTION

The present invention is directed to methods and kits for facilitating detection of a plurality of respiratory viruses. For example, contemplated samples, kits, and methods can detect at least two respiratory viruses using a multiplexed diagnostic assay. The respiratory virus can be any DNA or RNA virus affecting the respiratory system including for example, an adenovirus, a coronavirus, an enterovirus, a rhinovirus, an influenza virus, a human metapneumovirus (HMPV), a human respiratory syncytial virus (HRSV), a human parainfluenza viruses (HPIV), as well as all sero- and genotypes and combinations thereof.

Any suitable RNA sample can be tested to determine the presence of at least one respiratory virus. Preferably, the sample comprises a bodily fluid. More preferably, the sample comprises a nasopharyngeal aspirate or nasal swab. Once the sample has been obtained, instructions can be provided to run RNA isolation and cDNA synthesis using reverse transcription. Of course, it should be appreciated that the nucleic acid that is isolated from the patient sample may be a viral RNA and/or a DNA, and most preferably, the RNA and/or DNA isolation is performed in a single step using commercially available reagents and supplies. Where the viral nucleic acid is an RNA it is especially preferred that the reverse transcription is performed in a single step reaction with the PCR.

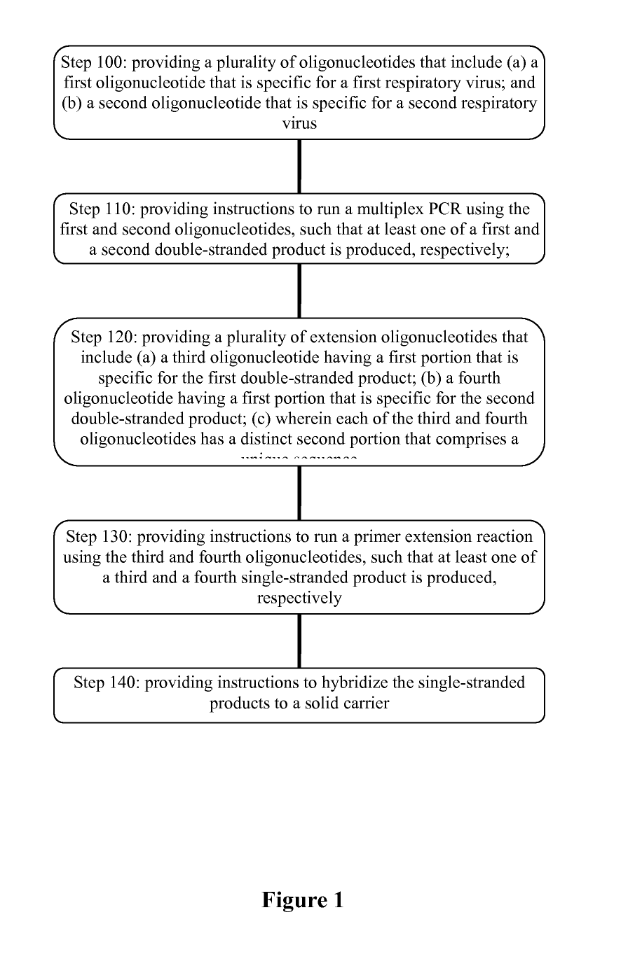

In a preferred aspect shown in FIG. 1, a method of facilitating the detection of a plurality of respiratory viruses is disclosed that uses a multiplexed diagnostic assay. Initially, a plurality of oligonucleotides can be provided that include first and second oligonucleotides specific for first and second respiratory viruses, respectively (step 100). The oligonucleotides are preferably selected from the group consisting of SEQ ID Nos. 1-23. The selected oligonucleotides can be specific for different sero- or genotypes of a respiratory virus, different respiratory viruses altogether, or mixtures thereof While it is contemplated that the oligonucleotides can comprise any practical length, preferably, the oligonucleotides have a length of between 12 and 40 nucleotides.

While specific sequences are provided herein, it is particularly contemplated that the oligonucleotides can be any equivalent sequence of those specified, which specifically hybridize to the targeted sequence of the original oligonucleotide and at approximately the same annealing temperature. For the PCR oligonucleotides, any equivalent sequence must also allow for multiplex PCR and primer extension with respective single temperature profiles. Preferably, the approximate annealing temperature is defined as a temperature within 2° C. of the average melting point of SEQ ID Nos. 1-23 and SEQ ID Nos. 47-81, respectively, under otherwise identical conditions. More preferably, the temperature is within 1° C., and most preferably, the temperature is within 0.5° C. In addition, the equivalent sequence must be relatively specific to the target sequence. As used herein, “relatively specific” is defined to allow for one or more mismatches of the nucleotide pairs at any portion of the sequence excluding the 3′ end, and preferably, excluding the last three nucleotides of the 3′ end, while still hybridizing to the intended viral sero-/genotype.

Such equivalent sequences can have one or more substitutions, deletions or additions for one or more of the nucleotides of the specified sequences. For example, one or more degenerate bases might be substituted for one or more nucleotides of the sequence. Contemplated equivalent sequences might also or alternatively include the use of non-natural bases including 7-deaza-guanine, 8-oxo-guanine, 6-mercaptoguanine, 4-acetylcytidine, 5-(carboxyhydroxyethyl)uridine, 2′-O-methylcytidine, 5-carboxymethylamino-methyl-2-thioridine, 5-carboxymethylaminomethyluridine, dihydrouridine, 2′-O-methylpseudouridine, β,D-galactosylqueosine, 2′-O-methylguanosine, inosine, N6-isopentenyladenosine, 1-methyladenosine, 1-methylpseeudouridine, 1-methylguanosine, 1-methylinosine, 2,2-dimethylguanosine, 2-methyladenosine, 2-methylguanosine, 3-methylcytidine, 5-methylcytidine, N6-methyladenosine, 7-methylguanosine, 5-methylaminomethyluridine, 5-methoxyaminomethyl-2-thiouridine, β,D-mannosylqueosine, 5-methoxycarbonylmethyluridine, 5-methoxyuridine, 2-methylthio-N6-isopentenyladenosine, N-((9-β-D-ribofuranosyl-2-methylthiopurine-6-yl)carbamoyl)threonine, N-((9-β-D-ribofuranosylpurine-6-yl)N-methylcarbamoyl)threonine, uridine-5-oxyacetic acid methylester, uridine-5-oxyacetic acid, wybutoxosine, pseudouridine, queosine, 2-thiocytidine, 5-methyl-2-thiouridine, 2-thiouridine, 2-thiouridine, 5-methylurdine, N-((9-β-Dribofuranosylpurine-6-yl)carbamoyl)threonine, 2′-O-methyl-5-methyluridine,2′-O-methyluridine, wybutosine, and 3-(3-amino-3-carboxypropyl)uridine.

Furthermore, any oligonucleotide backbone can be employed including for example, DNA, RNA (although less preferred), modified sugars such as carbocycles, and sugars containing 2′-substitutions such as fluoro- and methoxygroups. The oligonucleotides can be oligonucleotides wherein at least one, or all, of the internucleotide bridging phosphate residues are modified phosphates, such as methyl phosphonates, methyl phosphonothioates, phosphoromorpholidates, phosphoropiperazidates and phosphoramidates (for example, every other one of the internucleotide bridging phosphate residues may be modified as described). The oligonucleotide can also be a peptide nucleic acid.

In a further contemplated aspect, at least two reverse oligonucleotides can be provided. Preferably, the reverse oligonucleotides are selected from the group consisting of SEQ ID Nos. 25-45, and specifically, the sequences that correspond to the plurality of oligonucleotides provided. With respect to equivalent sequences, the same conditions as discussed above for SEQ ID Nos. 1-23 apply.

Once the first and second oligonucleotides have been provided, instructions can then be provided to run a multiplex PCR using the oligonucleotides, which can produce first and second double-stranded products, respectively (step 110). A labeled dNTP can be used to distinguish the various products of the multiplex PCR. Preferably, the labeled dNTP is a fluorophor. However, the labeled dNTP can be a dNTP having any atom or molecule that can provide a detectable signal. Labels can provide signals detectable by various techniques including for example, colorimetric, fluorescent, electrophoretic, electrochemical, spectroscopic, chromatographic, chemiluminescent, densitometric, and radiographic techniques. Labels can also be molecules that can only produce a detectable signal when used with another label including for example, a quencher of a quencher-dye pair, and an enzyme-catalyzed conversion of a dye.

After running the multiplex PCR (which may be performed in the same tube and reaction sequence than the reverse transcription), a SAP/EXO mixture can optionally be provided to destroy the oligonucleotides and remaining dNTPs from the PCR reaction. Instructions to run a cleanup cycle using the SAP/EXO mixture can also be provided. This is advantageous, as the process helps ensure clean and properly labeled DNA sequences.

In a further contemplated aspect, a plurality of extension oligonucleotides can be provided that include third and fourth oligonucleotides specific for first and second double-stranded products, respectively (step 120). The extension oligonucleotides are preferably selected from the group consisting of SEQ ID Nos. 47-81. With respect to equivalent sequences, the same conditions as discussed above for SEQ ID Nos. 1-23 apply. In addition, the third and fourth oligonucleotides can have distinct second portions that each comprise a unique sequence. The sequence can be any sequence that allows for later distinction and identification of the oligonucleotides. For example, the unique second portions can be used to hybridize the extension oligonucleotides to a solid carrier as described by Fan, et al., in volume 10 of Genome Research on pages 853-860. While it is contemplated that the unique sequences can comprise any practical length, preferably, the unique sequences have a length of between 8 and 50 nucleotides. More preferably, the unique sequences have a length of between 12 and 25 nucleotides.

A spacer can be used to couple the first and second portions to improve hybridization to a solid phase, and any commercially available spacer is deemed suitable for use herein. For example, contemplated spacers include an internal three carbon spacer, a photo-cleavable spacer, a six carbon glycol spacer, a triethylene glycol spacer, an 18-atom hexaethylene glycol spacer, and a 1′,2′-dideoxyribose.

Once the third and fourth oligonucleotides have been provided, instructions can then be provided to run a primer extension reaction using the oligonucleotides, which can produce third and fourth single-stranded products, respectively (step 130). Advantageously, the single-stranded products can be labeled to allow the single-stranded products to be easily detected and differentiated. Any suitable label can be used including for example, those labels discussed above.

After providing instructions to run a primer extension reaction, instructions can then be provided to hybridize the single-stranded products to a solid carrier (step 140). Any type of solid carrier capable of immobilizing the extension products can be used. In one embodiment, the solid carrier can be a chip. Any suitable chip can be used, and preferably the chip is configured to immobilize the single-stranded products in a predetermined pattern. Most preferably, the solid carrier is configured as a microarray. In an alternate embodiment, the solid carrier can be a plurality of color-coded beads on which the single-stranded products are immobilized. Preferably, each bead color corresponds to the unique sequence of the second portion of an oligonucleotide. Thus, for example, each virus and subsets within a virus might correspond to a specific color of bead.

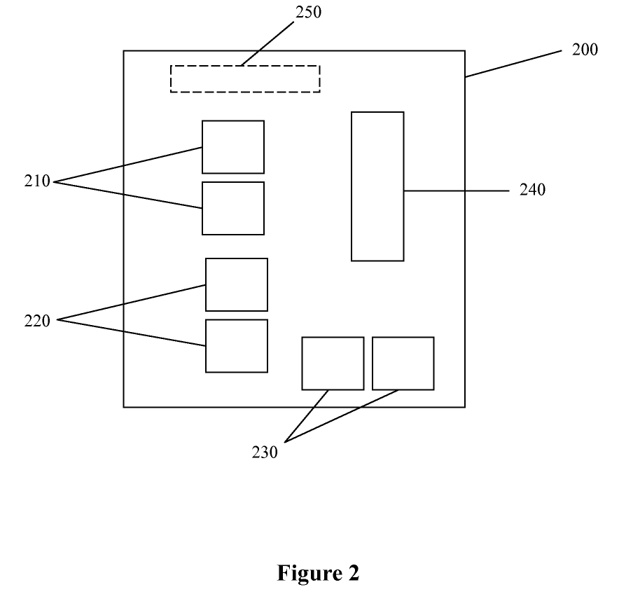

In further contemplated aspects, a kit is provided, an example of which is illustrated in FIG. 2. The kit 200 comprises at least two oligonucleotides 210. Preferably, the oligonucleotides 210 are selected from the group consisting of SEQ ID Nos. 1-23. It is also contemplated that the kit can include at least two reverse oligonucleotides 220, which are preferably selected from the group consisting of SEQ ID Nos. 25-45. More preferably, the reverse oligonucleotides are selected to form an amplicon with one of the first and second oligonucleotides 210. As discussed above, it is contemplated that all oligonucleotides presented herein can also include any equivalent sequence of the specified sequences, provided the equivalent sequence retains the same approximate annealing temperature and specificity as the original sequence. It is also contemplated that the kit 200 can include a plurality of extension oligonucleotides 230, which are preferably selected from the group consisting of SEQ ID Nos. 47-81. Optionally, the kit can contain a SAP/EXO mixture 250.

The kit can also comprise a solid carrier 240. Any suitable carrier that immobilizes nucleic acids can be used as solid carrier 240. In one embodiment, the solid carrier comprises a plurality of single-stranded nucleic acids in respective predetermined positions. In another embodiment, the solid carrier comprises a plurality of color-coded beads. Preferably, each of the same color beads comprises a plurality of single-stranded nucleic acids having the same nucleotide sequences. In addition, the solid carrier can comprise a microarray. Preferred solid carriers are described in U.S. Patent Publication Numbers US 2004/0005697 (pub. January 2004) and US 2005/0221283 (pub. October 2005). These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### EXAMPLE

Comparison of microarray and real-time PCR assays for the diagnosis of respiratory viruses in children

Specimen Collection and Preparation

The inventors tested nasopharyngeal aspirate (NPA) specimens of 221 children ≦3 years old who were hospitalized between November 2001 and April 2002 for an acute respiratory infection with an onset of symptoms within ≦7 days as previously described. NPAs were aliquoted and stored at −80° C. Clinical information and clinical laboratory results were prospectively collected. Before nucleic acid extraction, NPAs were thawed on ice and 0.5 μl A of Armored RNA was added to each NPA. Nucleic acid extraction was performed with the QiAmp Viral RNA mini kit (QIAGEN, Mississauga, Ontario) using the protocol suggested by the manufacturer. The final elution volume was 40 μl. Reverse transcription was done using Superscript II Reverse Transcriptase (Invitrogen, Carlsbad, Calif.). Reaction solution was composed of 1 μl of 50 ng/μl random primer (Amersham, Piscataway, N.J.), 1 μl of 10 μM dNTPs and 10 μl of extracted RNA. It was incubated at 65° C. for 5 min, then put on ice. The following was then added to the solution: 4 μl of 5× first strand Buffer (Invitrogen), 2 μl of 0.1 M DTT (Invitrogen) and 1 μl of 40 U/μl RNAsin (Promega, Madison, Wis.). The solution was incubated at room temperature for two minutes, then 200 units of Superscript II (Invitrogen) was added. The solution was incubated at room temperature for 10 min, then at 42° C. for 50 min and finally at 70° C. for 15 min. The cDNA was kept at −20° C.

Primers and Probes

PCR primers used in the multiplex PCR are those listed in SEQ ID Nos. 1-46. PCR primers used in the real-time PCR assay are those listed in SEQ ID Nos. 83-123. TaqMan were specific to the real-time PCR assay, and included the primers listed in SEQ ID Nos. 124-147. The TaqMan sequences comprise a fluorescent portion (6-Carboxyfluorescein (6FAM) or VIC from Applied Biosystems) coupled to the 5′ end, and a molecular-groove binding non-fluorescence quencher (MGBNFQ) coupled to the 3′ end. All primers were obtained from Invitrogen Canada. TaqMan-MGB probes were obtained from Applied Biosystems (Streetsville, Ontario). Multiplex PCR primer mix contains all PCR primers at concentrations ranging between 50 and 200 nM, depending on the targeted virus. Primers used for primer extension are composed of a tag sequence followed by a specific detection sequence. The primers used for primer extension are those listed in SEQ ID Nos. 47-82 (tag sequences not shown). Tag sequences hybridize to the microarray.

Quantitative Reverse Transcription PCR (qRT-PCR) Assay

To compare the multiplex PCR/primer extension/solid phase hybridization to a PCR-Taqman assay, the following qRT-PCR assay was developed and performed with substantially the same amplification primers as described above. All reactions were performed in a 96 well plate using TaqMan Universal PCR mastermix (Applied Biosystems) in an ABI 7500 apparatus (Applied Biosystems). PCR primers were used at a 200 nM concentration and TaqMan probes were used at a 250 nM concentration. Each 96 well PCR plate allows for the testing of four specimens, one positive and negative control for each virus. Each specimen tested uses 16 wells of the plate, testing one virus species per well, along with one well targeting the Armored RNA internal control. One pl of specimen cDNA or control was added to each well of the plate. The PCR program consisted in the following steps: 2 min at 50° C., 10 min at 95° C., followed by 50 cycles of 15 s at 95° C., 15 s at 55° C. and 40 s at 60° C.

INFINITI Microarray Assay

Multiplex PCR was performed in a T1plus thermocycler (Biometra, Montreal Biotech, Montreal). The amplification solution was composed of 10× buffer, 0.2 μM dNTPs, 1.5 mM MgC12, multiplex PCR primer mix, 0.5 units of Platinum Taq DNA polymerase (Invitrogen Canada), and 2.5 μl of cDNA. The PCR program consisted in the following steps: 60 s at 94° C. followed by 39 cycles of 30 s at 94° C., 30 s at 55° C. and 60 s at 72° C. The reaction was then incubated at 72° C. for 3 min. Then, 3 units of Shrimp Alkaline Phosphatase (Clontech, Mountain View, Calif.), 7.5 units of exonuclease (Clonetech) and 0.25 μl of 50× Titanium DNA polymerase (Clontech) were added to the solution, which was incubated at 37° C. for 50 minutes and at 94° C. for 20 minutes. RVP Primer extension solution (AutoGenomics, Carlsbad, Calif.) was then added to the solution. Primer extension reaction consisted in the following steps: 60 sat 94° C. followed by 39 cycles of 15 s at 94° C. and 15 s at 50° C. Following the primer extension reaction, 80 μl of hybridization solution (AutoGenomics) was added to each reaction. The total volume of 120 μl was then hybridized to a DNA microarray (AutoGenomics) for 90 minutes at 42° C. at high humidity. After hybridization each chip was washed 5 times with 300 μl of 1× SSC. Chips were dried and scanned on the INFINITI system (AutoGenomics).

Results

Sensitivity of the Real-Time PCR Assay

Both techniques yielded excellent results for each targeted virus when tested with laboratory isolates or, if no isolate was available for a virus, with a synthetic oligonucleotide of the targeted sequence. For both assays, primer sets were modified until all appropriate isolates or oligonucleotides were properly detected by each method. The inventors also conducted sensitivity for the studied viruses, using cloned amplicons when the virus was available or using synthetic oligonucleotides. Sensitivities of each TaqMan qRT-PCR assay ranged from 10 copies to 1000 copies per reaction, depending on the targeted virus, as shown in Table 1 (below):

TABLE 1
Sensitivity of qRT-PCR assay.

| | | | | Sensitivity |
|---|---|---|---|---|
| Virus | Gene | Method | Threshold | (copy number) |
| Adenovirus | IVA2 | Plasmid | 40 | 10 |
| Coronavirus 229E | Nucleocapsid | Not performed | 39 | NA |
| Coronavirus HKU1 | Nucleocapsid | Oligo | 40 | 50 |
| Coronavirus NL63 | Nucleocapsid | Not performed | 45 | NA |
| Coronavirus OC43 | Nucleocapsid | Plasmid | 45 | 50 |
| Coronavirus SARS | Corp | Oligo | 40 | 1000 |
| Enterovirus/Rhinovirus | 5′ UTR | Plasmid | 40 | 1000 |
| Influenza A | Nucleocapsid | Plasmid | 40 | 50 |
| Influenza B | Nucleocapsid | Plasmid | 42 | 10 |
| HMPV A | Matrix | Plasmid | 40 | 50 |
| HMPV B | Matrix | Plasmid | 40 | 50 |
| HRSV A | Nucleocapsid | Plasmid | 45 | 1000 |
| HRSV B | Nucleocapsid | Plasmid | 45 | 10 |
| PIV-1 | Nucleocapsid | Plasmid | 43 | 50 |
| PIV-2 | Fusion | Not performed | 40 | NA |
| PIV-3 | Nucleocapsid | Plasmid | 44 | 50 |
| PIV-4 | Nucleocapsid | Plasmid | 45 | 100 |

Comparison of Real-Time PCR Assay with the Microarray Assay

The study included 221 specimens obtained in 2001-2002 from children less than three years old hospitalized for respiratory infections. Specimens were considered positive for one virus if they were positive by either one of both methods. Of the 221 specimens, 81.9% of the specimens were positive for at least one virus and 18.1% of specimens were negative for all viruses by both methods. Furthermore, 69.2% of the specimens were positive for one virus, 13.1% of the specimens were positive for two viruses, and 1.4% of the specimens were positive for three viruses. 37.5% of co-infections included adenoviruses (p <0.001, Fisher Exact Test).

Table 2 (below) shows the percentage of specimens infected by each virus as detected by any of the two methods. The most frequently detected virus was HRSV, with 38% HRSV type B and 10% HRSV type A. Influenza A and picornaviruses (rhinoviruses or enteroviruses) were each detected in 13.1% of specimens. Adenovirus, coronavirus, human metapneumovirus and parainfluenzavirus were detected in 7.2%, 9.0%, 5.9% and 1.5% of specimens, respectively.

TABLE 2
Proportion of virus detected (n = 221).

| Virus | Percentage |
|---|---|
| Adenovirus A, B or C | 7.2% |
| Adenovirus D, E or F | 0.0% |
| Coronavirus 229E | 0.0% |
| Coronavirus HKU1 | 4.1% |
| Coronavirus NL63 | 3.6% |
| Coronavirus OC43 | 1.4% |
| Coronavirus SARS | 0.0% |
| Influenza A | 13.1% |
| Influenza B | 0.0% |
| Human metapneumovirus A | 4.1% |
| Human metapneumovirus B | 1.8% |
| Human parainfluenzavirus 1 | 0.5% |
| Human parainfluenzavirus 2 | 0.5% |
| Human parainfluenzavirus 3 | 0.5% |
| Human parainfluenzavirus 4 | 0.0% |
| Human respiratory syncytial virus A | 10.0% |
| Human respiratory syncytial virus B | 38.0% |
| Rhinovirus or Enterovirus | 13.1% |

Specimens were considered positive if positive with either qRT-PCR or microarray.

For some viruses, the virus type was also identified. Due to methodological design, it was only possible to identify virus types for adenoviruses and rhinovirus with the microarray assay. Of the 10 specimens positive on microarray for adenoviruses, 4 were adenovirus type B and 6 were adenovirus type C. Of the 29 specimens positive for respiratory picornaviruses, 21 were positive for rhinoviruses and 8 for enteroviruses. Of the 21 rhinoviruses, the inventors were able to identify the type of 20 with the microarray assay, which were all rhinoviruses of genotype A. Respiratory syncytial virus types were identified for all HRSV positive specimens at percentages of 21% for type A and 79% for type B. Human metapneumovirus types were also identified for all positive specimens at percentages of 69% for type A and 31% for type B. Coronavirus of types HKU1, NL63 and OC43 were identified in 4.1%, 3.6%, 1.4% of specimens, respectively.

Overall, 78.7% of the 221 specimens were positive for at least one virus with both techniques, 18.1% were negative for all viruses by both methods and 3.2% (7/221) were positive for at least one virus with qRT-PCR only, as shown in Table 3 (below). No viruses were detected with the microarray method only.

TABLE 3
Comparison of qRT-PCR and microarray results for 221 specimens.

| | Positive | Positive | | | | |
|---|---|---|---|---|---|---|
| | TaqMan/ | TaqMan/ | | | | |
| | Positive | Negative | Negative TaqMan/ | Negative TaqMan/ | Sensitivity of | Specificity of |
| Virus | microarray | microarray | Positive microarray | Negative microarray | microarray | microarray |
| Adenovirus | 10 | 6 | 0 | 205 | 0.625 | 1.000* |
| Coronavirus 229E | 0 | 0 | 0 | 221 | NA | 1.000 |
| Coronavirus HKU1 | 8 | 1 | 0 | 212 | 0.889 | 1.000 |
| Coronavirus NL63 | 5 | 3 | 0 | 213 | 0.625 | 1.000 |
| Coronavirus OC43 | 3 | 0 | 0 | 218 | 1.000 | 1.000 |
| Coronavirus SARS | 0 | 0 | 0 | 221 | NA | 1.000 |
| Enterovirus/Rhinovirus | 26 | 3 | 0 | 192 | 0.897 | 1.000 |
| Influenza A | 27 | 2 | 0 | 192 | 0.931 | 1.000 |
| Influenza B | 0 | 0 | 0 | 221 | NA | 1.000 |
| HMPV A | 4 | 5 | 0 | 212 | 0.444 | 1.000* |
| HMPV B | 4 | 0 | 0 | 217 | 1.000 | 1.000 |
| HRSV A | 22 | 0 | 0 | 199 | 1.000 | 1.000 |
| HRSV B | 83 | 1 | 0 | 137 | 0.988 | 1.000 |
| PIV-1 | 1 | 0 | 0 | 220 | 1.000 | 1.000 |
| PIV-2 | 1 | 0 | 0 | 220 | 1.000 | 1.000 |
| PIV-3 | 1 | 0 | 0 | 220 | 1.000 | 1.000 |
| PIV-4 | 0 | 0 | 0 | 221 | NA | 1.000 |

*Virus for which results where significantly different between qRT-PCR and microarray were marked with a star (McNemar, p <0.05).

The results with both methods were compared for each specimen and a concordance in diagnostic was observed in 90.5% of the specimens. Of the 9.5% (21/221) specimens with discordant results, 6 were positive for adenovirus, 5 for HMPV A, 3 for a picornaviridae, 3 for coronavirus NL63, 2 for influenza A, 1 for HRSV B, and 1 for coronavirus HKU1. For a particular virus, specimens positive with real-time PCR and negative with the microarray assay usually have higher cycle threshold than specimens positive with both methods (data not shown). This suggests an increased sensitivity of the real-time PCR assay for these viruses. This seems especially true for adenoviruses, for which the real-time PCR assay detects up to 10 copies of the target sequence. As compared with the qRT-PCR assay, no false positive is observed when the microarray assay is used, which suggests a high specificity for the microarray assay.

Discussion

The comparison of the qRT-PCR and the microarray assays showed that both techniques were able to detect and identify many different respiratory viruses in clinical specimens, either present as single agents or as parts of a co-infection.

When diagnostic for each virus is compared separately, a perfect concordance between the two methods is observed for HRSV type A and B, parainfluenzaviruses, HMPV type B and coronavirus OC43. This, along with the demonstration that the 46-primer multiplex PCR assay gives a results similar to simplex or duplex real-time PCR assay in over 90% of the specimens tested, suggests that this technique is sensitive and specific, and that it can be used for clinical diagnostics.

Although 9.5% (21/221) of specimens have viruses detected only by the real-time PCR assay, the discordant viruses restricted to adenoviruses, HMPV type A, coronaviruses HKU1 and NL63, influenza A and rhinoviruses. In the case of coronaviruses, influenza and rhinoviruses, this is solely a sensitivity issue, because the microarray assay does give a signal for these specimens, although the signal is lower than the threshold required to call these viruses positive. In the case of adenoviruses and HMPV A, it is important to note that adenoviruses and HMPV are the only viruses for which the PCR primers are different between the two assays. The inventors suspect that there is either a large difference in sensitivity between the two techniques or that there are sequence variations accounting for the discordant detection of these viruses. However, the inventors were unable to sequence the discordant HMPV A specimens. In the case of the discordant adenovirus specimens, the use of three different primer sets, including the one used in real-time PCR, has not allowed to resolve these discordant specimens. Still, 3 out of 4 discordant adenovirus specimens were confirmed by DNA sequencing.

A limitation of the qRT-PCR assay is that it is actually limited to 16 wells for each specimen studied, making it more difficult to identify new respiratory virus or to perform typing with the same setting. Thus, this test does not discriminate between adenovirus, enterovirus and rhinovirus types. Also, the real-time PCR assay hardly discriminates between enteroviruses and rhinoviruses, while the microarray assay clearly identifies these two viruses. Moreover, the microarray assay has enough probes available to identify the types of these three virus families and, if necessary, it would be possible to add new targets to the microarray assay, such as bocavirus or avian influenza, without removing other targets.

From a technical viewpoint, the qRT-PCR 96-well plate assay is labor intensive, time consuming and has low throughput, allowing the testing of only four samples per 96-well plate. On the contrary, the microarray assay, when automated using the INFINITI system, requires fewer human intervention and allows the testing of up to 24 samples per run. When twelve or less samples are tested, the overall time required for the real-time PCR assay is shorter than the time required for the microarray assay. However, when twelve or more samples need to be processed, the time required for the microarray assay is shorter, assuming only one thermocycler is available for real-time PCR. Moreover, for any number of samples, the automated microarray assay requires only 35 minutes of setup time, while the real-time PCR assay requires around an hour per four specimens for 96-well plate preparation. The reduction of hands-on time of the microarray assay could be a financial advantage of this technique. Due to its automation, the INFINITI assay is also potentially less susceptible to manipulation errors and to cross-contamination than plate-based qRT-PCR.

Thus, specific embodiments and applications of genotyping a plurality of respiratory viruses have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of facilitating detection of a plurality of respiratory viruses using a multiplexed diagnostic assay, the method comprising:
providing a plurality of oligonucleotides that include
(a) a first oligonucleotide that is specific for a first respiratory virus; and
(b) a second oligonucleotide that is specific for a second respiratory virus; providing instructions to run a multiplex PCR using the first and second oligonucleotides, such that at least one of a first and a second double-stranded product is produced, respectively;
providing a plurality of extension oligonucleotides that include
(a) a third oligonucleotide having a first portion that is specific for the first double-stranded product;
(b) a fourth oligonucleotide having a first portion that is specific for the second double-stranded product;
(c) wherein each of the. third and fourth oligonucleotides has a distinct second portion that comprises a unique sequence;
providing instructions to run a primer extension reaction using the third and fourth oligonucleotides, such that at least one of a third and a fourth single-stranded product is produced, respectively;
wherein the third and fourth oligonucleotides are selected from the group consisting of SEQ ID Nos. 47-81; and
providing instructions to hybridize the single-stranded products to a solid carrier.

2. The method of claim I wherein the first and second oligonucleotides are selected from the group consisting of SEQ ID Nos. 1-23.

3. (canceled)

4. The method of claim 1, further comprising providing at least two reverse oligonucleotides selected from the group consisting of SEQ ID Nos. 25-45.

5. The method of claim 1, further comprising a step of providing instructions to run cDNA synthesis on a sample of RNA using reverse transcription.

6. The method of claim 1 wherein the step of providing instructions to run a primer extension reaction produces labeled third and fourth products.

7. The method of claim 1 wherein the solid carrier comprises a chip to which the single-stranded products are immobilized in a predetermined pattern.

8. The method of claim 1 wherein the solid carrier comprises a plurality of color-coded beads, wherein beads of same color have same nucleotide sequences of the hybridized single-stranded products.

9. The method of claim 1 wherein the solid carrier comprises a microarray.

10. The method of claim 1 wherein the step of providing instructions comprises instructing a user to run the multiplex PCR using a labeled dNTP.

11. The method of claim 10 wherein the labeled dNTP comprises a fluorophor.

12. The method of claim 1, further comprising a step of providing a SAP/EXO mixture and providing instructions to run a cleanup cycle using the SAP/EXO mixture.

13. A kit for genotyping at least one respiratory virus comprising at least two oligonucleotides selected from the group consisting of SEQ ID Nos. 1-23, and at least two extension oligonucleotides selected from the group consisting of SEQ ID Nos. 47-81.

14. The kit of claim 13, further comprising at least two reverse oligonucleotides selected from the group consisting of SEQ ID Nos. 25-45.

15. The kit of claim 13, further comprising a solid carrier.

16. The kit of claim 15 wherein the solid carrier comprises a plurality of single-stranded nucleic acids in respective predetermined positions.

17. The kit of claim 15 wherein the solid carrier comprises a plurality of color-coded heads, wherein beads of same color comprise a plurality of single-stranded nucleic acids haying same nucleotide sequences.

18. The kit of claim 15 wherein the solid carrier comprises a microarray.

19. The kit of claim 13, further comprising a SAP/EXO mixture.
